(19) United States
(12) Patent Application Publication
(10) Pub. No.: US 2004/0257742 A1
(43) Pub. Date: Dec. 23, 2004

(54) Voltage limiter

(76) Inventors: Peter Zeller, Pichl bei Wels (AT); Falko Schietzsch, Oberentfelden (CH); Jutta Barlage, Forchheim (DE)

Correspondence Address: BURNS DOANE SWECKER & MATHIS L L P, POST OFFICE BOX 1404, ALEXANDRIA, VA, 22313-1404, US

(21) Appl. No.: 10/491,747

(22) PCT Filed: Jul. 11, 2002
(86) PCT No.: PCT/CH02/00378

(30) Foreign Application Priority Data
Oct. 18, 2001 (EP) 01811019.7

(51) Int. Cl. H02H 9/06

(52) U.S. Cl. 361/118

(57) ABSTRACT

The voltage limiter is used to effectively limit short-term and long-term overvoltages. Said voltage limiter has a varistor (1) and a discharge path which can be connected in parallel with the varistor. The discharge path contains a switching point (4), which is preferably in the form of a semiconductor switch and can be loaded with an uninterrupted current, and which can be closed above a limit value of a signal which is dependent on an operating variable of the varistor (1). The varistor (1) is arranged in a first area (24) and the switching point (4) is arranged in a second area (26) of two areas (24, 26, 28) which are at an axial distance from one another in the direction of an axis of symmetry (20). Means (5) for operating the switching point (4) are accommodated in a third area (28), which is at a defined potential.

The arrangement of the components (1, 4, 5) of the voltage limiter in separate areas (24, 26, 28) results in a compact, modular construction, and those components of the voltage limiter which are subject to power loading, namely the varistor (1) and the switching point (5), are physically separated from one another, so that they can be cooled independently of one another. Since the operating means (5), which generally operate electronically, are accommodated in an electromagnetically shielded area (28), the operational reliability of the voltage limiter is at the same time improved, and, in particular, undesirable high-energy electromagnetic interference is kept away from this area (28).

### TECHNICAL FIELD

The invention is based on a voltage limiter as claimed in the precharacterizing clause of patent claim 1. This voltage limiter is used to limit short-term or long-term overvoltages. The voltage limiter has a varistor and a discharge path which can be connected in parallel with the varistor. In the event of long-lasting overvoltages, a switching point which is provided in the discharge path is operated, and commutates a current, which is carried in the varistor when limiting overvoltages, into the discharge path.

### PRIOR ART

The precharacterizing clause of the invention refers to a prior art for voltage limiters as is described in U.S. Pat. No. 4,068,281 A. The described limiting apparatus has a varistor 10, in parallel with which a discharge path with a semiconductor switch 16 is connected. When a long-lasting overvoltage occurs, the varistor carries current which, after a time delay which can be predetermined, is commutated into the discharge path by short-circuiting the semiconductor switch. The short circuit is achieved via an NTC thermistor 15, which switches on the semiconductor switch as a function of the varistor temperature after the time delay has elapsed.

A further voltage limiter is disclosed in FR 2,716,307 A. FIG. 2 of this document illustrates a voltage limiter with a spark gap 2, in parallel with which a discharge path with a semiconductor switch 8 is connected. A variable which is dependent on the operation of the spark gap 2, namely the voltage, across the spark gap, is detected by a control device 9 and is used to short-circuit the semiconductor switch after a predetermined time interval.

A voltage limiter having a number of voltage-limiting elements is described in DE 41 24 321 A1. If one of these elements is overloaded during operation, then a switching operation takes place from this element to a next voltage-limiting element. Since the connected voltage-limiting element is likewise quickly overloaded in the event of long-term overvoltages, this limiter is not suitable for long-lasting overvoltages.

### DESCRIPTION OF THE INVENTION

The invention, as it is defined in the patent claims, achieves the object of specifying a voltage limiter of the type mentioned initially, which is distinguished by a compact construction and by high reliability even in severe operating conditions.

The voltage limiter according to the invention has an axially symmetrical housing with at least two areas, which are at a distance from one another in the axial direction, and of which the varistor is arranged in a first and the switching point is arranged in the second. It also contains a third area, which is at a defined potential and in which means for operating the switching point are accommodated. The arrangement of the components of the voltage limiter in separate areas results in a compact, modular construction. At the same time, this ensures that those components of the voltage limiter which are subject to power loading, namely the varistor and the switching point, are physically separated from one another, and can thus be cooled independently of one another. Since the operating means, which generally operate electronically, are accommodated in an electromagnetically shielded area, the operational reliability of the voltage limiter is improved to a very major extent. In this way, in particular, undesirable high-energy electromagetic interference is kept away from this area.

A particularly compact construction with particularly good electromagnetic compatibility at the same time is achieved if the third area is arranged between the first area and the second area and contains a control device as the operating means with inputs for at least one signal, which is dependent on an operating variable, and for further signals which are dependent on the operating variables and may be provided, having a trigger unit which checks switching conditions and produces a switching signal, an output which acts on the switching point, a signal processing unit which processes the signals which are dependent on an operating variable, and/or an amplifier which amplifies the switching signals. A control device such as this makes it possible to monitor the formation of the switching signal very accurately, independently of disturbing electromagnetic interference fields. The processing of the supplied signals in the signal processing unit and/or the amplification of the switching signal in the amplifier allow/allows the accuracy of the process to be additionally improved. A further improvement is achieved by inputs for additional, preferably external, input signals and by electronics or computation unit, integrated in the trigger unit, for linking the signals which are dependent on an operating variable and the additional input signals in accordance with a control algorithm which is determined by the switching conditions. A voltage limiter such as this may be used particularly advantageously for railroad operation, since, despite the occurrence of severe interference fields there, extremely accurate and reliable operation of the voltage limiter is required even for carrying out complex limiting tasks.

The operating variable is, in particular, a current carried by the varistor, the magnetic field of this current, a residual voltage which is present across the varistor and/or the temperature of the varistor. If the residual voltage is chosen as the operating variable, the control apparatus has a trigger element which can be activated above a limit value of the residual voltage and is in the form of a voltage divider or voltage limiter, if the varistor current or its magnetic field is chosen as the operating variable, the control apparatus has a trigger element which can be activated above a limit value of the current or of the magnetic field and is in the form of a switch which is dependent on the current density or magnetic field strength, if the varistor temperature is chosen as the operating variable, the control apparatus has a trigger element which can be activated above a temperature limit value and is in the form of a temperature-dependent switch.

The first area and the second area are arranged in a physically simple manner between in each case two of four current-carrying plates, which are at an axial distance from one another and are aligned at right angles to the axis of symmetry. Here, two outer plates each form one of two current connections of the arrangement, and two inner plates, located between them, are electrically isolated from one another and are each electrically conductively connected to one of the two current connections of the arrangement and to one of two current connections of the varistor and of the switching point. If, now, a first of the two outer plates and a first of the two inner plates are braced with respect to one another in an electrically conductive manner by means of first screws, and a second inner plate, which is arranged between the first outer plate and the first inner plate, and a second of the outer plates are braced with respect to one another in an electrically conductive manner by means of second screws, then highly effective protection against external mechanical influences can be achieved using supporting elements which already exist in the limiter housing, without additional holding parts.

The first screws are expediently passed through openings in the second inner plate, and the second screws are passed through openings in the first inner plate, which openings are larger than the screws. A voltage limiter designed in this way can be produced particularly easily, since its parts which can carry different electrical potentials can easily be electrically isolated from one another. Flat insulation is used as the insulation means, which is provided between one of the two outer plates and one of the two inner plates, and insulation which embeds the two inner plates and extends between the two outer plates, which is advantageously formed by a cured encapsulation compound.

The electrically and magnetically shielded third area is preferably bounded by the first inner plate and by an intermediate plate which is kept at its electrical potential and is electrically conductively connected to a current connection of the varistor. The third area, which contains the operating means, is then particularly effectively protected against electromagnetic influences by being in the form of a Faraday cage.

Major assistance to the assembly of the voltage limiter is provided by introducing a centering pin, which is passed into the second area, into the first inner plate. This centering pin holds the switching point, which generally has at least one power semiconductor, in a defined position during manufacture of the voltage limiter and after its production.

### DESCRIPTION OF THE DRAWINGS

The invention will be explained in the following text with reference to exemplary embodiments. In the figures:

FIG. 1 shows an outline circuit diagram of the arrangement according to the invention for limiting short-term and long-term overvoltages U, having a varistor and having a discharge path which is connected in parallel with the varistor and has a switching point which can be controlled by an operating variable of the varistor,

FIG. 2 shows an outline circuit diagram of one embodiment of the voltage limiter according to the invention as shown in FIG. 1, in which the residual voltage U_{R} of the varistor, which is dependent on the overvoltage, is used as the operating variable for controlling the switching point,

FIG. 3 shows an outline illustration of the profile of the residual voltage U_{R} which occurs across the voltage limiter as shown in FIG. 2, of a current I which is caused by the overvoltage U, of a current I_{V} which is carried in the varistor, and of a current I_{S} which flows through the switching point, in each case as a function of time t,

FIG. 4 shows a circuit diagram of one embodiment of the voltage limiter as shown in FIG. 2 for alternating current applications and with a switching point which contains two back-to-back parallel-connected thyristors,

FIG. 5 shows a circuit diagram of one embodiment of the voltage limiter as shown in FIG. 2 for direct current applications, with a thyristor as the switching point,

FIG. 6 shows a circuit diagram of one embodiment of a further voltage limiter as shown in FIG. 2 for alternating current applications, for a switching point which contains two back-to-back parallel-connected thyristors,

FIG. 7 shows a circuit diagram of one embodiment of the voltage limiter as shown in FIG. 1 for direct current applications, with a thyristor as the switching point, in which the current Iᵥ flowing through the varistor and the temperature T of the thyristor are used as the operating variables for controlling the switching point,

FIG. 8 shows a circuit diagram of one embodiment of the voltage limiter as shown in FIG. 1 for alternating current applications, with a back-to-back parallel-connected thyristor arrangement as the switching point, in which the current Iᵥ flowing through the varistor and the temperature Tᵥ of the varistor are used as the operating variables for controlling the switching point,

FIG. 9 shows a circuit diagram of one embodiment of the voltage limiter as shown in FIG. 1 for direct current applications, with an IGBT as the switching point, in which the current I_{V} flowing through the varistor and the temperature Tᵥ of the varistor are used as the operating variables for controlling the switching point,

FIG. 10 shows a circuit diagram of one embodiment of the voltage limiter as shown in FIG. 1 for alternating current applications, with a back-to-back parallel-connected IGBT arrangement as the switching point, in which the current Iᵥ flowing through the varistor and the temperature Tᵥ of the varistor are used as the operating variables for controlling the switching point,

FIG. 11 shows a perspective illustration of one embodiment, which is in the form of an apparatus, of one of the voltage limiters as shown in one of FIGS. 4, 6, 8 or 10, in which the insulation which is otherwise present has been removed,

FIG. 12 shows a side view of the voltage limiter as shown in FIG. 11, which is illustrated partially cut away in the region of two power semiconductors, which are used as the switching point, and

FIG. 13 shows a plan view on a section along XIII-XIII through the voltage limiter as shown in FIG. 11, in which the insulation is now present, however.

### APPROACHES TO IMPLEMENTATION OF THE INVENTION

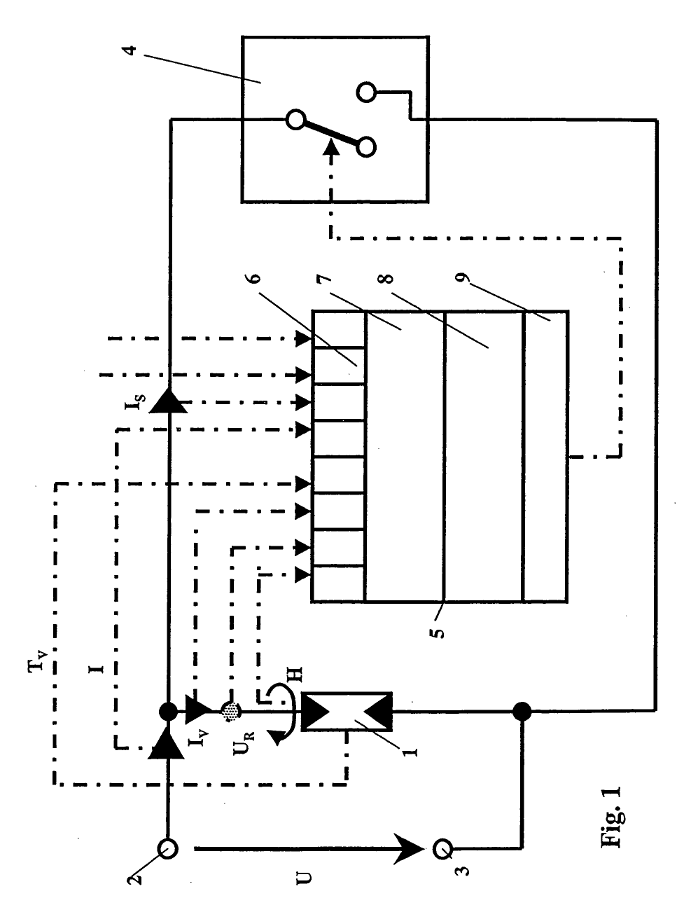

Identical parts are provided with the same reference symbols in the figures. The voltage limiter which is illustrated in FIG. 1 has a voltage-limiting element, which is in the form of varistor 1 and preferably contains metal oxide, in particular zinc oxide. The varistor 1 is connected in parallel with a path to which overvoltages U can be applied and which is bounded by two current connections 2, 3, which may be of different potentials. The two current connections may be part of one electrical system, but may also each be associated with one of two different electrical systems, for example with a rail of an electrical track carrying a return current, and a low-voltage system arranged in the vicinity of the track, for example an automatic ticket machine. The current connection 2 is electrically conductively connected to one of the two current connections of the varistor 1, and to one of the two current connections of the switching point 4, which is arranged in a discharge path connected in parallel with the varistor 1. The current connection 3 and the other of the two current connections of the varistor 1 and switching point 4 are each at the same potential. Means which cause the switching point to be operated, in particular to be switched on, are located between the varistor and the switching point. These operating means comprise sensors, which are not identified, for detection of operating variables of the varistor, and a control device 5 to which the output signals from the sensors are supplied, and which acts on the switching point 4. Operating variables such as these include all measurement variables which make it possible to identify that the varistor is overloaded, in particular such as a current Iᵥ which is carried in the varistor 1 and can be detected by a current sensor, the magnetic field H of this current, which can be detected by a magnetic field sensor, a residual voltage U_{R} which is present across the varistor 1, and the temperature Tᵥ of the varistor 1, which can be detected by a temperature sensor. Only one of the operating variables may act on the switching point 4. However, in order to improve the redundancy, it may be expedient to allow two or more of the operating variables to act on the switching point 4. Depending on the embodiment, the sensors may be integrated in the control device 5.

The control device 5 has inputs 6 for the signals I_{V}, U_{R}, T_{V} and H which are emitted from the sensors and are dependent on an operating variable, and for further signals which are dependent on an operating variable and which may be provided. Such further signals are a current I caused by the overvoltage U and a current I_{S} carried in the discharge path and in the switching point 4, which is added to the varistor current I_{V} to form the total current I caused by the overvoltage. Inputs are also provided for additional signals from external control lines. The input signals can be processed in a signal processing unit 7 of the control device 5. A switching-on signal for the switching point is formed from the processed signals in a trigger unit 8, while checking predetermined tripping conditions directly or indirectly with the aid of an algorithm which assesses the processed input signals in a computation unit or in electronics. The switching signal may be amplified in an amplifier 9, and may be passed to a control element for the switching point 4, via one output of the control device 5.

The switching point 4 may be in the form of an electromechanical switching device, but will in general have a semiconductor switch containing power semiconductors. Suitable power semiconductors are in the form of thyristors, triacs transistors, IGBTs, GTOs, MOSFETs or FETs. The individual power semiconductor types differ in their load capacity (overload behavior, voltage load, maximum permissible current rate of rise) and the trigger methods. Each semiconductor type thus has different advantages for specific applications, so that the optimum type can be evaluated on the basis of the application. Depending on which power semiconductor is used, type-specific protection circuits (for example a surge suppressor protection circuit for a thyristor) and disconnection circuits (for example a commutation aid circuit for a thyristor) may be integrated. For alternating current applications, the semiconductor switch is in general designed to be bidirectional and contains two identical power semiconductors which are connected back-to-back in parallel while, in contrast, for direct current applications, only one power semiconductor or two or more power semiconductors in the same polarity are used.

An overvoltage which lasts for only a short time and whose energy content is low is limited by the varistor 1. A long-term overvoltage with a high energy content is likewise initially limited by the varistor 1. Before the load on the varistor becomes too great, a switching signal is formed in the control device 5 above a limit value of at least one signal which is dependent on one of the operating variables I_{V}, U_{R}, T_{V}, H of the varistor, and this switching signal short-circuits the switching point, whose uninterrupted current load capacity is greater than that of the varistor, provided that the signal which is dependent on an operating variable is still above the limit value after a predetermined time interval.

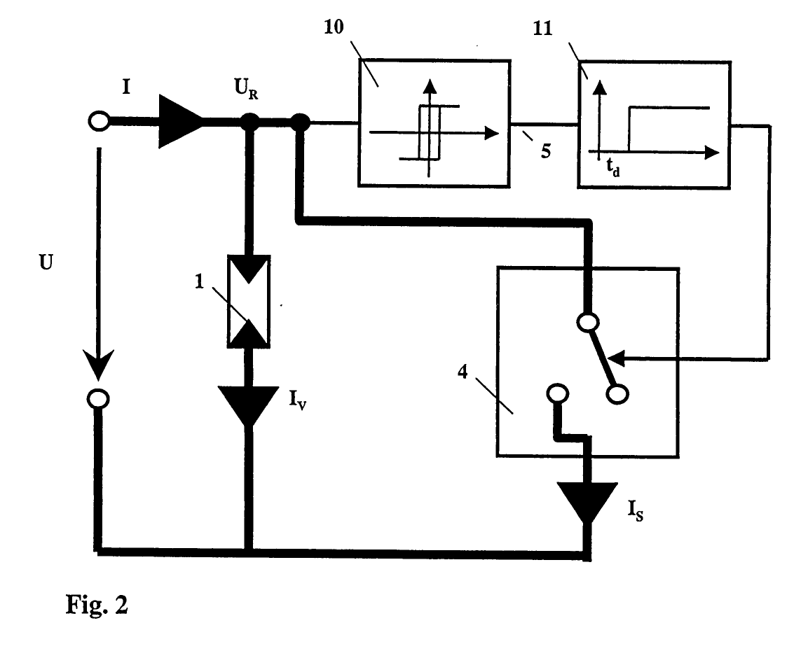

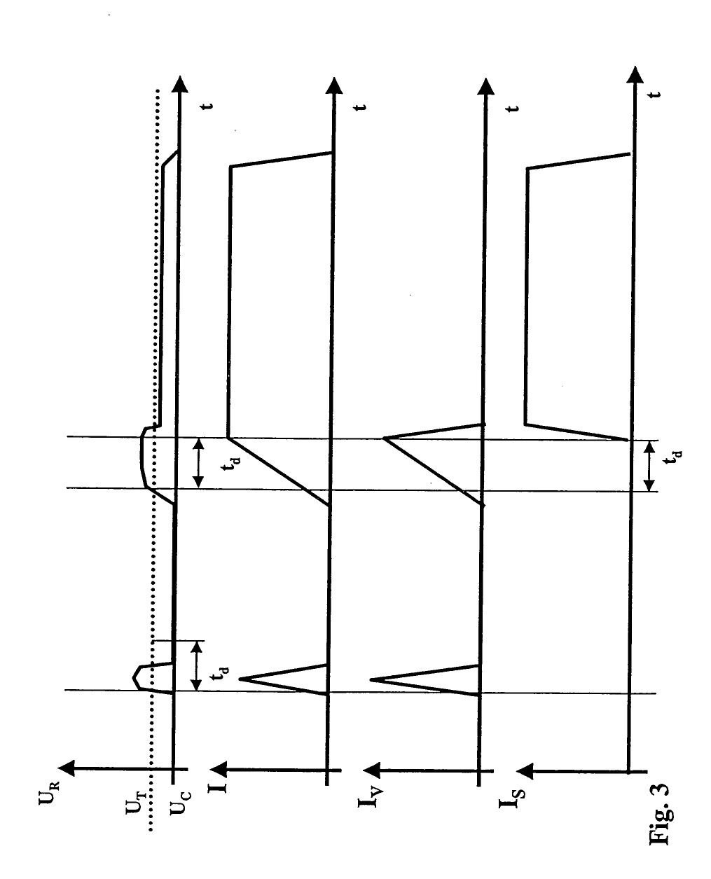

This principle will be explained with reference to FIGS. 2 and 3 for a voltage limiter according to the invention, in which the residual voltage U_{R} which corresponds to the overvoltage, across the varistor is used as the operating variable for controlling the switching point 4. The control device 5, which is connected firstly to that current connection of the varistor 1 which carries the residual voltage U_{R} and secondly to the control element of the switching point 4, of this voltage limiter has, connected in series with it, a trigger element 10 and a time delay element 11 with a time delay which acts over a time interval t_{d}.

When a short-term overvoltage occurs (left-hand part of FIG. 3), then the varistor 1 becomes conductive when the overvoltage is greater than a predetermined value U_{C}, and then carries a current I_{V}. If the overvoltage exceeds a further predetermined voltage value U_{T}, then the trigger element 10 emits a trigger signal, and the time delay element 11 is activated at the same time. If the overvoltage U falls below the value U_{T} once again within the time interval t_{d}, then the trigger signal disappears once again during this time interval. The overvoltage is then limited exclusively by the varistor 1, without any risk of overloading. If, on the other hand, this is an overvoltage which acts for a long time and may rise slowly (right-hand part of FIG. 3), then the trigger signal which is emitted by the trigger element 10 is maintained over the entire time interval t_{d}. Once this time interval has elapsed, the trigger signal passes via the time delay element 11 as a switching signal to the switching point 4, and closes the switching point 4, forming a discharge path. The current I_{V} carried in the varistor 1 is now commutated into the discharge path containing the switching point 4. Since the switching point 4 is designed to be resistant to uninterrupted currents, it can carry the current for a long time interval without being heated to an unacceptable extent. Nevertheless, any excess heat which may occur can be dissipated via cooling elements that are additionally provided.

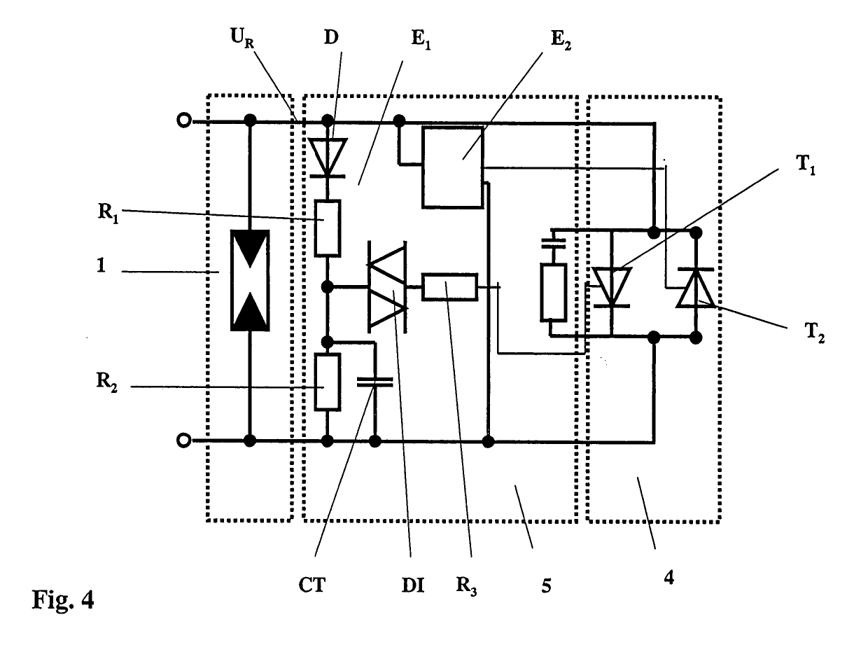

In the embodiment of the voltage limiter which is shown in FIG. 4, the residual voltage U_{R} of the varistor 1 is used to control the switching point 4, which is in the form of bidirectional switches with two back-to-back back parallel-connected thyristors T₁ and T₂. During the positive half-cycle of the residual voltage, the residual voltage U_{R} of the varistor 1 is detected via a diode D by a voltage divider which is connected in parallel with the current connections of the varistor 1 and has non-reactive resistors R₁ and R₂ for electronics E₁ of the control circuit 5. During the positive half-cycle of the residual voltage, the residual voltage, which is reduced by the division factor of the voltage divider, is supplied via a diac DI and a non-reactive resistor R₃ to the gate connection of the thyristor T₁. An energy storage capacitor CT for the electronics E₁, which is connected in parallel with the resistor R₂, is then charged. If the residual voltage is still present after the time interval t_{d} (FIG. 3), then the capacitor CT is charged to a voltage which is sufficient to activate the diac and to carry current from the capacitor CT via the resistor R₃ to the gate electrode of the thyristor T₁. The gate current is limited by the resistor R₃ and causes the thyristor T₁ to be triggered, thus reducing the load on the varistor 1 which is connected parallel with the thyristor T₁.

The electronics E₂, which can be seen in FIG. 4, are designed in a corresponding manner to the electronics E₁ and, during the negative half-cycle of the residual voltage, cause a capacitor which corresponds to the capacitor CT to be charged and, if the residual voltage is still present after the time interval t_{d}, cause the thyristor T₂ to be triggered. An RC circuit, which is normal for thyristors and is not identified in any more detail, protects the thyristors T₁ and T₂ against being overloaded.

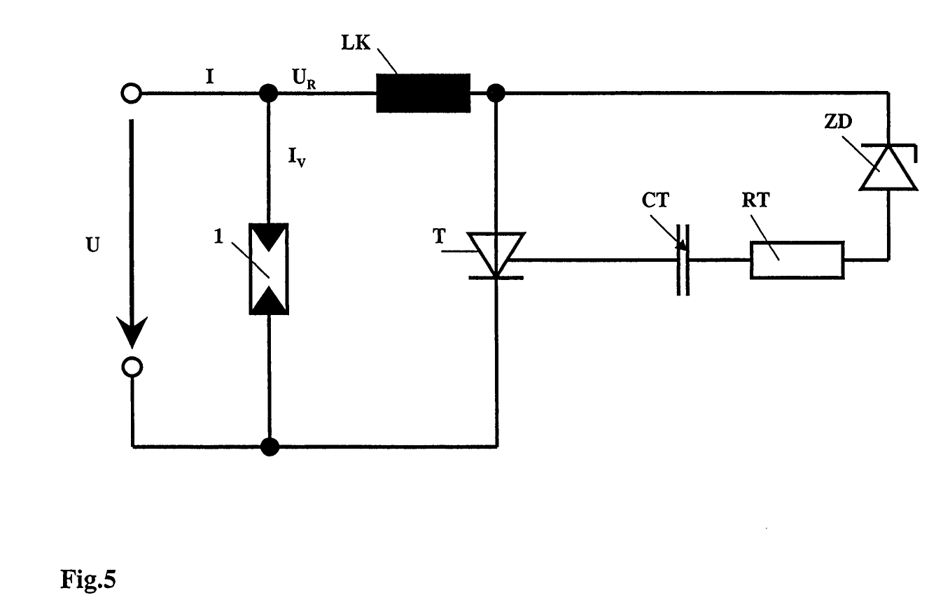

The embodiment of the voltage converter as shown in FIG. 5, which is intended for direct current applications, also uses the residual voltage U_{R} of the varistor 1 to control the switching point. The switching point is in the form of a thyristor T. The gate electrode of the thyristor T is driven by the residual voltage via a zener diode ZD and a series circuit, which is thus connected in series with it and is formed by a non-reactive resistor RT and a capacitance CT. A signal is passed to the thyristor T only when the zener diode ZD is conducting above the voltage value U_{T} (FIG. 3) and still remains conducting, as well, after a time delay which is governed by the RC element. A protection inductor LK ensures that the rise in the current I_{S} through the switching point takes place in a controlled manner while the varistor current I_{V} is being commutated from the varistor 1 into the discharge path. The thyristor T is thus protected against excessively high current rates of change.

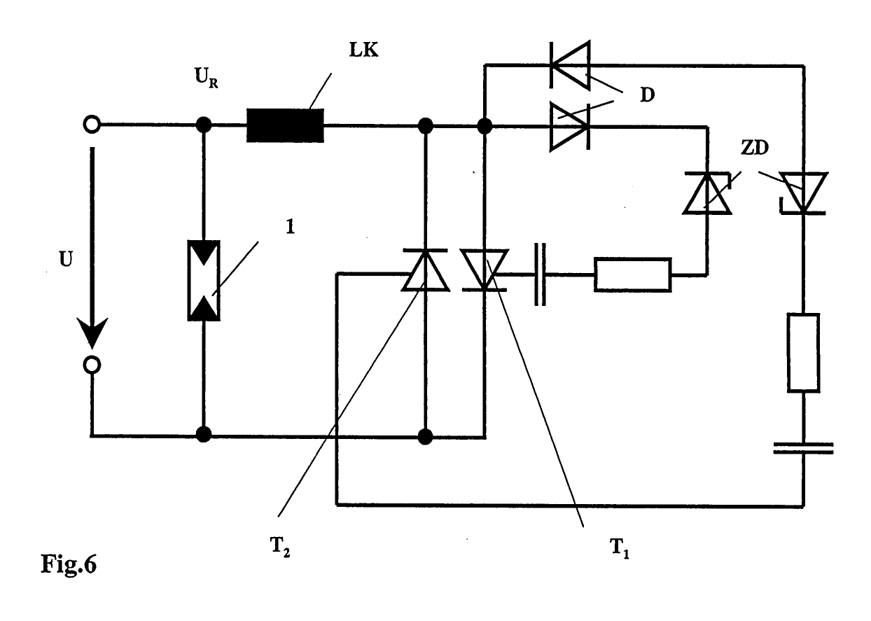

In the embodiment as shown in FIG. 6, which is intended for alternating current applications, the switching point 4 is once again in the form of a thyristor arrangement with two thyristors T₁ and T₂ connected back-to-back in parallel. Each of these two thyristors is connected, in a corresponding way to the thyristor T in the embodiment shown in FIG. 4, to the zener diode ZD and to the RC element. Two back-to-back parallel-connected diodes D, which are each connected upstream of one of the two zener diodes, ensure that only one half-cycle of the signal which corresponds to the residual voltage U_{R} is in each case passed on to zener diode ZD.

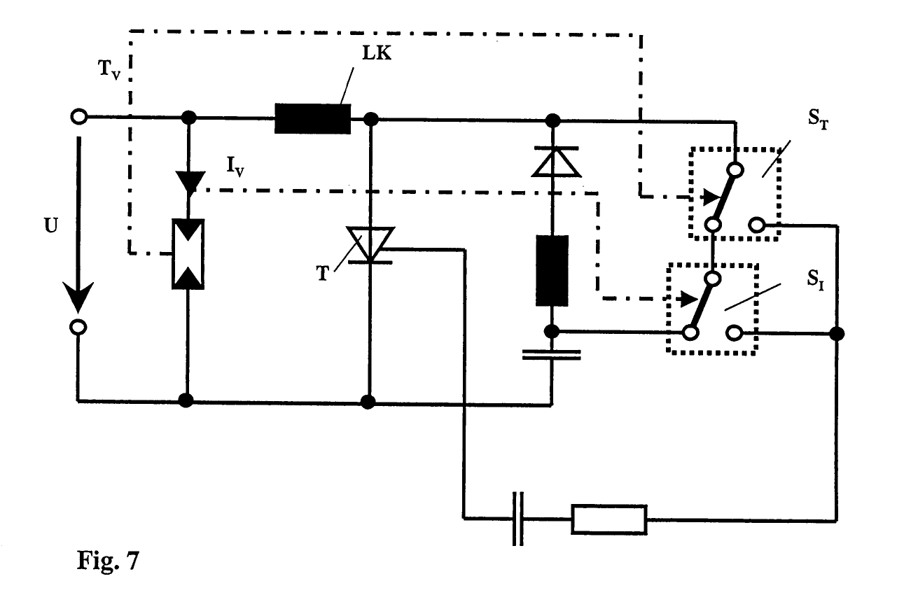

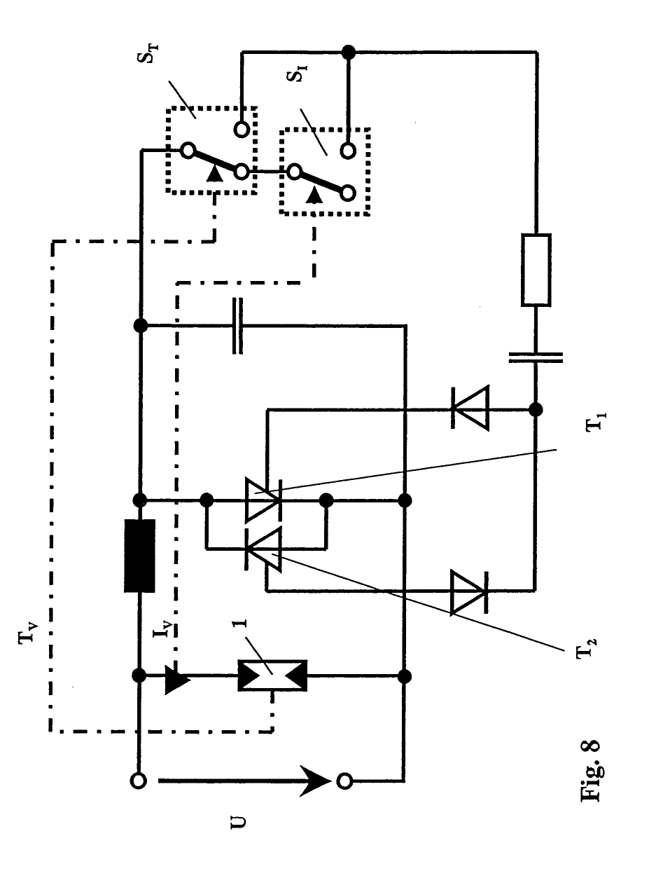

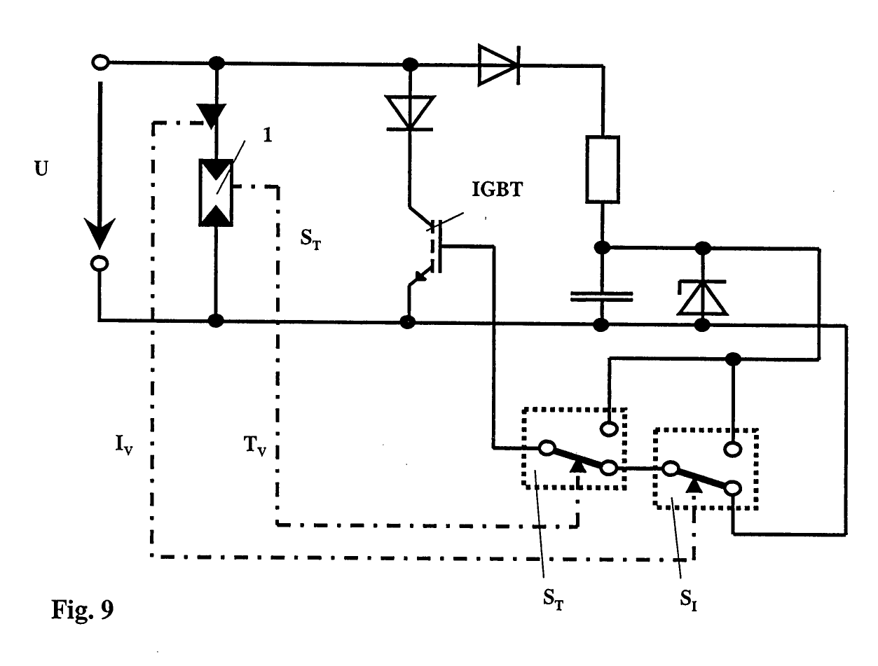

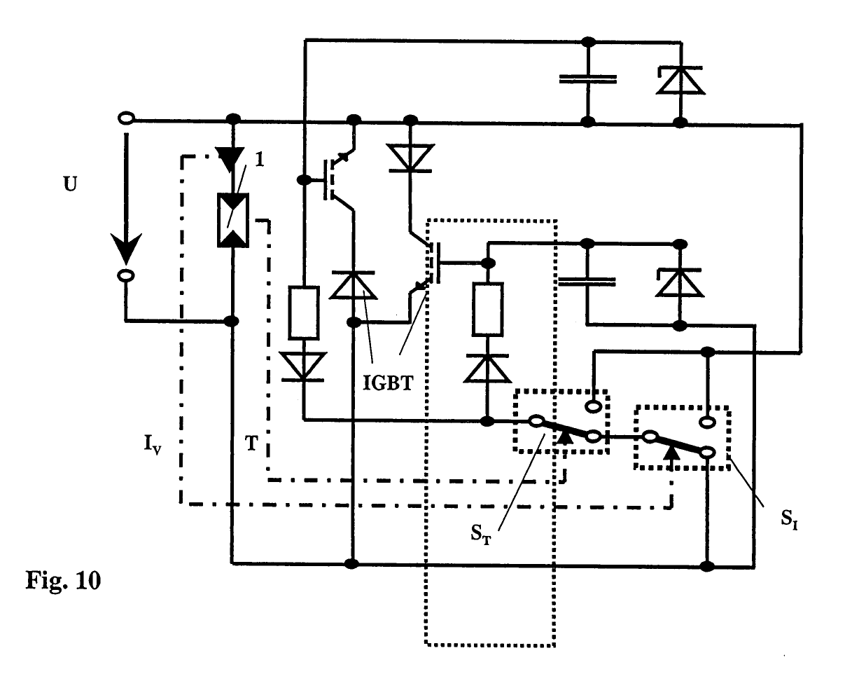

In the embodiments shown in FIGS. 7 to 10, and in contrast to the embodiments shown in FIGS. 2, 4, 5 and 6, the varistor current I_{V} and the temperature T_{V} of the varistor are used as the operating variables for operating the switching point 4. Instead of the zener diode ZD, a switch S_{I} which can be activated above a limit value of the current or of the magnetic field and is dependent on the current density or magnetic field strength, and a temperature-dependent switch S_{T} which can be activated above a limit value of the temperature T_{V}, are now provided as the trigger element. In the embodiments shown in FIGS. 7 and 9, which are intended for direct current applications, a thyristor T and an IGBT, respectively, are provided as the switching point 4. In the embodiments shown in FIGS. 8 and 10, which are intended for alternating current applications, an arrangement with two back-to-back parallel-connected thyristors T₁ and T₂ and an arrangement with two back-to-back parallel-connected insulated gate bipolar junction transistors (IGBT) are provided as the switching point 4. In the embodiments shown in FIGS. 9 and 10, with a switching point 4 containing at least one IGBT, there is no need for the protection inductor LK.

If one of the two switches S_{I} or S_{T} is closed in response to a limit value of the varistor current I_{V} or of the varistor temperature T_{V} being exceeded, then a tripping signal is passed to the switching point 4. Since two operating variables which act independently of one another are used to form the tripping signal, the redundancy of the voltage limiter is increased.

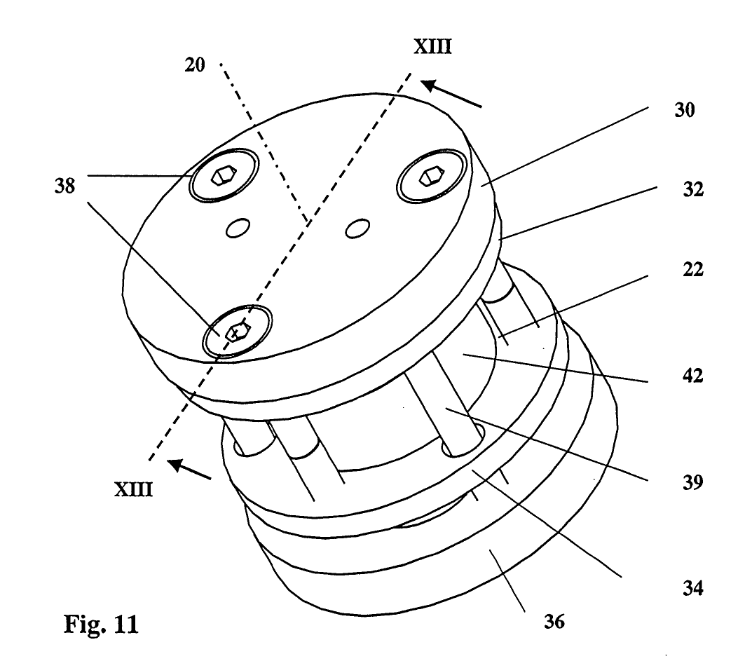

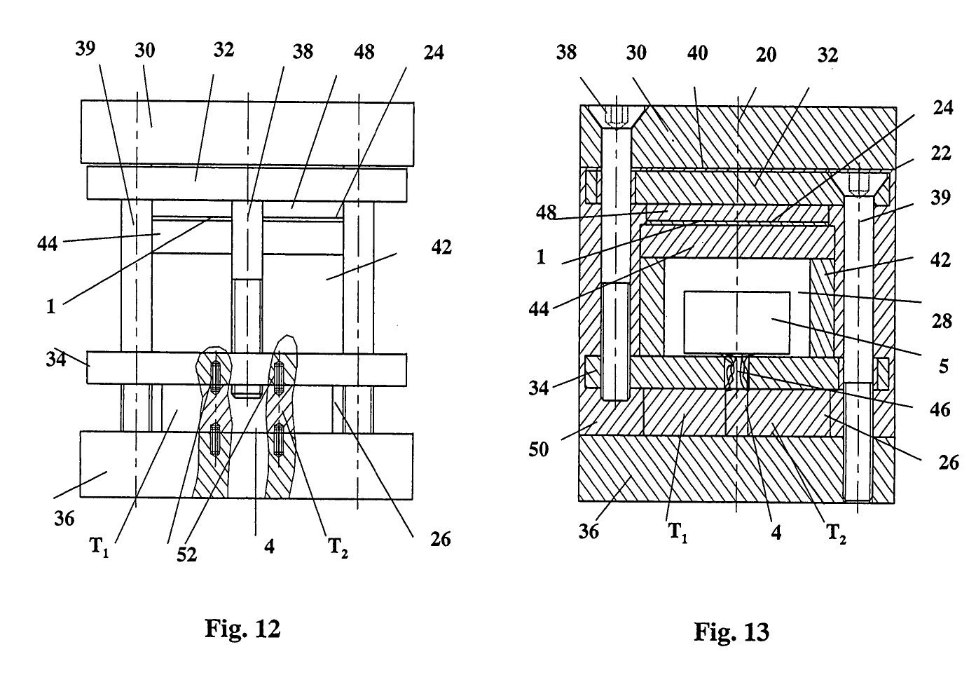

FIGS. 11 to 13 show a hardware embodiment of the voltage limiter as shown in one of the FIGS. 4, 6, 8 or 10, which is intended to accept high power levels. FIGS. 11 and 12 do not show the insulation. As can be seen, the voltage limiter has a housing 22 which is axially symmetrical along an axis 20 and has two areas 24 and 26 (FIGS. 12 and 13), which are at a distance from one another in the axial direction and of which the varistor 1, which is in the form of a flat circular disk, is arranged in a first area 24, while the switching point 4, which has two completely cylindrical thyristors T₁ and T₂, is arranged in the second 26. The operating means, which comprise the control device 5, are accommodated in a third area 28 (FIG. 3), which is electromagnetically shielded and is at a defined potential. This third area is arranged between the varistor area 24 and the switching point area 26.

It can be seen from FIGS. 12 and 13 that the areas 24 and 26 are arranged between in each case two electrically conductive plates 30, 32, 34, 36 which are axially at a distance from one another, are aligned at right angles to the axis of symmetry 20, and are of a round circular design. These plates are composed of a material with a high electrical conductivity, such as aluminum, brass or copper, of an alloy containing at least one of these elements, or of steel. Two outer plates of these plates, namely the plates 30 and 36, have a larger diameter than the two inner plates 32 and 34, and each form one of the two current connections of the voltage limiter. The inner plates 32 and 34 located in between them are electrically isolated from one another, and are each electrically conductively connected to one of the two current connections of the arrangement, and to one of two current connections of the varistor 1 and of the switching point 4. The plates 30 and 34 are braced with respect to one another in an electrically conductive manner by means of three screws 38, and the plate 32, which is arranged between these two plates and the plate 36 are braced with respect to one another in an electrically conductive manner by means of three screws 39. The screws 38 are passed through openings, which are not identified, in the plate 32, and the screws 39 are passed through openings, which are not identified, in the plate 34, which openings are larger than the screws.

The area 28 is bounded by the plate 34, a metallic hollow cylinder 42 which is based on the plate 34, and an electrically conductive intermediate plate 44, which is supported on the hollow cylinder 42 and forms a current connection of the varistor 1. Since the plate 34, the cylinder 42 and the intermediate plate 44 are electrically conductively connected to one another, the area 28 is at a defined potential, and is virtually completely electromagnetically shielded from the outside. An opening, which is not identified, is provided only in the plate 34, connects the area 28 to the switching point area 26 and accommodates supply and signal lines 46 (FIG. 13), which ensure that current is supplied to the control device 5 and ensure the signal flowing between the control device 5 and the gate electrodes of the thyristors T₁ and T₂.

Flat insulation 40, which is in the form of a flat layer (FIG. 13) is provided between the plates 30 and 32. The plates 30 and 34, the screws 38, the hollows cylinder 42 and the intermediate plate 44 are thus at the same potential once an AC voltage has been applied to the current connection of the voltage limiter, which are formed by the plates 30 and 36. In contrast, the plates 32, 36, the screws 39 and an intermediate plate 48 which supports the plate 32 and is used as a current connection for the varistor 1 are at the same opposite potential. As can be seen from FIG. 13, the embedding of the two inner plates 32 and 34, of the screws 38 and 39, of the intermediate plates 44 and 48, of the hollow cylinder 42, of the varistor 1 and of the thyristors T₁ and T₂ in an electrically insulating [lacuna] results in insulation 50 being formed, which extends between the two outer plates 30 and 36 and ensures reliable operation of the voltage limiter even when high power loads are applied. The insulation 50 is advantageously produced by extrusion coating the preassembled housing 22, which already holds the varistor, the thyristors and the control device, with an insulating resin, in particular based on silicone. Since the openings which hold the screws 38 and 39 are larger than the screws, the liquid resin can enter the opening and, once it has cured, can form insulation between the screws and the plates which have the openings.

As can be seen from FIG. 12, centering pins 52, which are passed into the area 26, are introduced into the plates 34 and 36. These pins hold the two thyristors T₁ and T₂ at predetermined points in the area 26, and make it considerably easier to assemble the voltage limiter.

### List of Reference Symbols

1 Varistor

2, 3 Current connections

4 Switching point

5 Control device

6 Inputs

7 Signal processing unit

8 Trigger unit

9 Amplifier

10 Trigger element

11 Time delay element

20 Axis

22 Housing

24, 26, 28 Areas

30, 32, 34, 36 Electrically conductive plates

38, 39 Screws

40 Flat insulation

42 Hollow cylinder

44, 48 Intermediate plates

46 Supply and signal lines

50 Insulation

52 Centering pins

I Total current

I_{V} Varistor current

I_{S} Current in the switching point

U Overvoltage

U_{C} Predetermined value of the overvoltage

U_{R} Residual voltage

U_{T} Limit value of the residual voltage

T_{V} Varistor temperature

H Magnetic field of the varistor current

t_{d} Time interval

T, T₁, T₂ Thyristors

D Diode

DI Diac

ZD Zener diode

IGBT IGBT

LK Limiting inductor

CT Capacitance

R₁, R₂, R₃, RT Non-reactive resistors

E₁, E₂ Electronics

1. An arrangement for limiting short-term or long-term overvoltages having
a varistor,
a discharge path which can be connected in parallel with the varistor and has a switching point whose uninterrupted current load capacity is greater than that of the varistor, and having means for operating the switching point above a limit value of a signal which is dependent on an operating variable of the varistor,
comprising an axially symmetrical housing having at least two areas, which are at a distance from one another in the axial direction and of which the varistor is arranged in a first area and the switching point is arranged in the second area, and by
an electromagnetically shielded third area, in which the operating means are accommodated.

2. The arrangement as claimed in claim 1, wherein the third area is arranged between the first area and the second area and contains a control device as the operating means, with inputs for the at least one signal which is dependent on an operating variable, and for further signals, which may be provided and are dependent on an operating variable, having a trigger unit which checks switching conditions and produces a switching signal, having an output which acts on the switching point, having a signal processing unit which processes the signals which are dependent on an operating variable, and/or having an amplifier which amplifies the switching signal.

3. The arrangement as claimed in claim 2, wherein the control device furthermore has inputs for additional input signals, as well as electronics or a computation unit, which is integrated in the trigger unit, for linking the signals which are dependent on an operating variable and the additional input signals in accordance with a control algorithm which is determined by the switching conditions.

4. The arrangement as claimed in claim 2, wherein the control device furthermore has inputs for additional input signals, as well as electronics or a computation unit, which is integrated in the trigger unit, for linking the signals which are dependent on an operating variable and the additional input signals in accordance with a control algorithm which is determined by the switching conditions.

5. The arrangement as claimed in claim 1, wherein the at least one operating variable is a current carried by the varistor, the magnetic field of this current, a residual voltage which is present across the varistor, and/or the temperature of the varistor.

6. The arrangement as claimed in claim 5, wherein the switching point has a power semiconductor which can be driven by the control device.

7. The arrangement as claimed in claim 6, wherein, if the residual voltage is chosen as the operating variable, the control apparatus has a trigger element which can be activated above a limit value of the residual voltage and is in the form of a voltage divider or voltage limiter.

8. The arrangement as claimed in claim 6, wherein, if the varistor current or its magnetic field is chosen as the operating variable, the control apparatus has a trigger element which can be activated above a limit value of the current or of the magnetic field and is in the form of a switch which is dependent on the current density or magnetic field strength.

9. The arrangement as claimed in claim 6, wherein, if the varistor temperature is chosen as the operating variable, the control apparatus has a trigger element which can be activated above a temperature limit value and is in the form of a temperature-dependent switch.

10. The arrangement as claimed in claim 2, wherein the first area and the second area are arranged between in each case two of four current-carrying plates, which are at an axial distance from one another and are aligned at right angles to the axis of symmetry, of which two outer plates each form one of two current connections of the arrangement, and two inner plates, located between them, are electrically isolated from one another and are each electrically conductively connected to one of the two current connections of the arrangement and to one of two current connections of the varistor and of the switching point.

11. The arrangement as claimed in claim 10, wherein a first of the two outer plates and a first of the two inner plates are braced with respect to one another in an electrically conductive manner by means of first screws, and a second inner plate, which is arranged between the first outer plate and the first inner plate, and the second of the outer plates are braced with respect to one another in an electrically conductive manner by means of second screws.

12. The arrangement as claimed in claim 11, wherein the first screws are passed through openings in the second inner plate, and the second screws are passed through openings in the first inner plate, which openings are larger than the screws.

13. The arrangement as claimed in claim 12, wherein the third area is electromagnetically shielded from the first inner plate and from an intermediate plate which is electrically conductively connected to a current connection of the varistor.

14. The arrangement as claimed in claim 13, wherein a centering pin, which is passed into the second area, is introduced into the first inner plate.

15. The arrangement as claimed in claim 10, wherein flat insulation is provided between one of the two outer plates and one of the two inner plates, and wherein the two inner plates are embedded in insulation which extends between the two outer plates.
